(19) United States
(12) Patent Application Publication
(10) Pub. No.: US 2024/0063404 A1
(43) Pub. Date: Feb. 22, 2024

(54) Dummy Cell for Fuel Cell and Fuel Cell Stack Including Same

(71) Applicants: Hyundai Motor Company, Seoul (KR); Kia Corporation, Seoul (KR)

(72) Inventors: Kyung Min Kim, Namyangju-si (KR); Jae Hyeon Choi, Incheon (KR)

(21) Appl. No.: 18/160,203

(22) Filed: Jan. 26, 2023

(30) Foreign Application Priority Data
Aug. 16, 2022 (KR) 10-2022-0102154

(51) Int. Cl. H01M 8/0271; H01M 8/2483; H01M 8/2457; H01M 8/1004

(52) U.S. Cl. CPC H01M 8/0271; H01M 8/2483; H01M 8/2457; H01M 8/1004

(57) ABSTRACT

In an embodiment a dummy cell includes a pair of dummy gas diffusion layers laminated on each other, a pair of separators which are laminated with the pair of gas diffusion layers interposed therebetween, and in which sealing gaskets forming an airtight line are disposed in an outer region of a region where the dummy gas diffusion layers are disposed and an airtight adhesive arranged between the dummy gas diffusion layers and the sealing gaskets and between the pair of separators, the airtight adhesive configured to prevent a reaction gas flowing from one separator to another separator.

### CROSS-REFERENCE TO RELATED APPLICATIONS

The present application claims priority of Korean Patent Application No. 10-2022-0102154, filed on Aug. 16, 2022, the entire contents of which is incorporated herein for all purposes by this reference.

### TECHNICAL FIELD

The present disclosure relates to a dummy cell for a fuel cell and a fuel cell stack including the same, and more particularly, to a dummy cell for a fuel cell, having a flow pressure of a reaction gas similar to that of a reaction cell, and a fuel cell stack including the same.

### BACKGROUND

A fuel cell, as a kind of power generation device that converts it into electrical energy by electrochemically reacting chemical energy of fuel in the stack, can be used not only to supply driving power for industrial use, household, and vehicles, but also to supply power for small electronic products such as portable devices, and its use area has recently been gradually expanding as a high-efficiency clean energy source.

Unit cells of a typical fuel cell have a membrane-electrode assembly (MEA) located at the innermost side thereof, and this membrane-electrode assembly includes a polymer electrolyte membrane that can move hydrogen cations (protons), and a catalyst layer applied to both surfaces of the electrolyte membrane so that hydrogen and oxygen can react with each other, that is, an anode electrode layer (anode) and a cathode electrode layer (cathode).

Further, a gas diffusion layer (GDL) is stacked on the outer portion of the membrane-electrode assembly, that is, the outer portion where the anode electrode layer and the cathode electrode layer are located, and a separator is positioned at the outer side of the gas diffusion layer and has a flow field formed therein so that fuel is supplied and water generated by the reaction is discharged through the flow field.

Since the general separator has a structure in which the land and the channel are repeatedly bent, the channel at one surface side facing the gas diffusion layer is used as a space through which a reaction gas such as hydrogen or air flows, and at the same time, as the channel at the opposite surface side is used as a space for cooling water to flow, one unit cell may be composed of a total of two separators such as one separator having a hydrogen/cooling water channel and one separator having an air/cooling water channel.

Meanwhile, a porous separator composed of a porous body and a flat plate has recently been used so that the reaction gas forms a turbulent flow and diffusion into the gas diffusion layer can be made more easily compared to the conventional general separator.

Thus, in general, a separator having channels and lands formed therein is applied to a fuel electrode through which hydrogen flows, and a porous separator is applied to an air electrode through which air flows.

In order to generate a desired level of output in the fuel cell, a plurality of unit cells having the configuration as described above are stacked in series to constitute a fuel cell stack. In the fuel cell stack, an end plate is coupled to the outermost side of the unit cells to support and fix the plurality of unit cells.

Meanwhile, the unit cells constituting the fuel cell stack largely include a plurality of reaction cells in which the reaction of the reaction gas is substantially performed, and at least one dummy cell disposed between the outermost reaction cell and the end plate in order to prevent deterioration of the reaction cells.

As described above, the reaction cell is configured by stacking a membrane-electrode assembly, a pair of gas diffusion layers, and a pair of separators, and since the dummy cell is not a power generation cell, the dummy cell is formed in a configuration in which the membrane-electrode assembly is omitted from the configuration of the reaction cells.

FIG. 1 is a view showing the configuration of a general fuel cell stack and the flow of reaction gas, FIG. 2A is a view showing a separator constituting a dummy cell of a general fuel cell stack, FIGS. 2B and 2C are views showing the main parts of FIG. 2A, and FIG. 3 is a view showing a cross section of a reaction cell and a dummy cell of a general fuel cell stack.

As shown in FIG. 1, a plurality of reaction cells 10 are stacked in a general fuel cell stack, and three dummy cells 20 are stacked in the outermost reaction cell 10.

At this time, in each reaction cell 10, a pair of gas diffusion layers 12 are laminated on both surfaces of the membrane-electrode assembly 11 as shown in FIG. 3, an anode separator 13 is laminated on the gas diffusion layer 12 on one side of the membrane-electrode assembly 11, and a cathode separator 14 is laminated on the gas diffusion layer 12 on the other side of the membrane-electrode assembly 11. At this time, a flow field-type separator is applied to the anode separator 13, and a porous separator composed of a flat plate 15 and a porous body 16 is applied to the cathode separator 14. In addition, a plurality of manifolds 13a and 15a through which hydrogen and air, that are reaction gases, and cooling water are flown in and discharged are formed on the flat plate 15 of the anode separator 13 and the cathode separator 14. In addition, sealing gaskets 13b and 15b which surround each of the manifolds 13a and 15a, and surround the reaction region in which the reaction of hydrogen and air is performed, thereby forming an airtight line are formed.

Further, the membrane-electrode assembly is not disposed in the dummy cell 20 as shown in FIG. 3, and after a pair of gas diffusion layers 22 are laminated on top of each other, the anode separator 23 is laminated on one side of the gas diffusion layers 22, and the cathode separator 24 is laminated on the other side of the gas diffusion layers 22. A plurality of manifolds 23a and 35a and sealing gaskets 23b and 25b are formed on the anode separator 23 and the cathode separator 24 constituting the dummy cell 20 as in the reaction cell 10.

In general, a dummy cell is divided into a closed dummy cell and an open dummy cell. The closed dummy cell is formed in a configuration in which all of the reaction gas inlets of an anode separator and a cathode separator are blocked so that the reaction gas is prevented from flowing into the unit cells as shown in FIG. 2C. The open dummy cell is formed in a configuration in which a gas inlet 25c having the reaction gas flown thereinto is formed in one separator of the anode separator and the cathode separator so that the reaction gas flows into the unit cells as shown in FIG. 2B.

The reaction gas is smoothly flown into the open dummy cell, but it is necessary to adjust the pressure of the open dummy cell similarly to that of the reaction cell 10. The reason is that when the reaction gas pressure in the dummy cell 20 is smaller than the reaction gas pressure in the reaction cell 10, the flow rate of the reaction gas flowing into the dummy cell 20 becomes higher than that of the adjacent reaction cell 10.

Then, the flow rate of the reaction gas flown into the reaction cell 10 adjacent to the dummy cell 20 is reduced, and accordingly, problems of degrading performance of the reaction cell and degrading discharge properties of produced water occur, and this causes deterioration of robustness of the fuel cell stack.

Meanwhile, in the reaction cells 10 as shown in FIGS. 1 and 3, hydrogen, which is a reaction gas, flows into a space between the gas diffusion layer 12 and the anode separator 13 laminated on one surface of the membrane-electrode assembly 11, and air, which is a reaction gas, flows into a space between the gas diffusion layer 12 and the cathode separator 14 laminated on the other surface of the membrane-electrode assembly 11.

The reason why hydrogen and air, which are reaction gases, separately flow into the anode separator side space (SA) and the cathode separator side space (SC) respectively is that a frame (hereinafter, referred to as “sub gasket 11a”) which surrounds and supports the membrane-electrode assembly 11 blocks a reaction gas flow between the anode separator side space (SA) and the cathode separator side space (SC).

Meanwhile, since the membrane-electrode assembly and the sub gasket are not configured in the dummy cell 20 to which an open dummy cell is applied, hydrogen, which is a reaction gas, may flow into the anode separator side space SA, and then flow to the cathode separator side space SC only, or as shown in FIG. 2a, air, which is a reaction gas, may flow into the cathode separator side space SC so that a portion of air may flow through the cathode separator side space SC, and the remaining portion thereof may flow into the anode separator side space SA.

Accordingly, one reaction gas selected from hydrogen or air, that is a reaction gas, for example, air flows only to the cathode separator side space SC in the reaction cell 10, but a phenomenon occurs in which the space in which air flows in the dummy cell 20 becomes larger than in the reaction cell 10 as it flows in both the cathode separator side space SC and the anode separator side space SA in the dummy cell 20.

Meanwhile, the flow rate of hydrogen or air, which is a reaction gas, flown into the reaction cell 10 and the dummy cell 20 should be equally distributed in the reaction cell 10 and the dummy cell 20, but since the volume of the path (space) through which hydrogen or air, that is a reaction gas, flows is larger in the dummy cell 20 than in the reaction cell 10 as described above, the differential pressure of the dummy cell 20 becomes lower than the differential pressure of the reaction cell 10, and the flow rate of the reaction gas flowing into the dummy cell 20 may be greater than the flow rate of the reaction gas flowing into the reaction cell 10 due to this.

Accordingly, as the flow rate of air that has to be flown into the reaction cell 10 is lost, there is a problem in that performance of the fuel cell stack deteriorates.

Particularly, as shown in FIG. 3, in the reaction cell 10, a section boa that is overcompressed as the membrane-electrode assembly 11 and the sub gasket 11a overlap occurs, but in the dummy cell 20, the gas diffusion layer 22 constituting the dummy cell 20 was manufactured to a small size in order to avoid the section boa that is overcompressed as the membrane-electrode assembly 11 and the sub gasket 11a overlap, and accordingly, as the space in which the cathode separator side space Sc and the anode separator side space SA communicate with each other increases, there is a problem in that the differential pressure imbalance is more increased as the difference between the differential pressure of the reaction gas in the reaction cell 10 and the differential pressure of the reaction gas in the dummy cell 20 is more increased.

The content described as the above background art is only for understanding the background of the present disclosure, and should not be taken as an acknowledgment that it corresponds to the conventional art already known to those with ordinary skill in the art.

### SUMMARY

Embodiments provide a dummy cell for a fuel cell, having a flow pressure of the reaction gas similar to that of a reaction cell by restricting a path through which a reaction gas flows in the dummy cell, and a fuel cell stack including the same.

A dummy cell for a fuel cell according to one embodiment of the present disclosure includes: a pair of dummy gas diffusion layers laminated on each other; a pair of separators which are laminated with the pair of dummy gas diffusion layers interposed therebetween, and in which sealing gaskets forming an airtight line are disposed in an outer region of a region where the dummy gas diffusion layers are disposed; and an airtight adhesive which is applied to a space between the dummy gas diffusion layers and the sealing gaskets between the pair of separators to prevent the reaction gas flown into one separator of the pair of separators from flowing to the other separator.

The compressibility of the airtight adhesive is greater than those of the dummy gas diffusion layers and the sealing gaskets.

The airtight adhesive is a hot melt-type pressure sensitive adhesive.

Meanwhile, a fuel cell stack according to one embodiment of the present disclosure includes a plurality of reaction cells stacked on each other and at least one pair of dummy cells stacked with a plurality of stacked reaction cells interposed therebetween, wherein the dummy cell includes: a pair of dummy gas diffusion layers laminated on each other; a pair of separators which are laminated with the pair of dummy gas diffusion layers interposed therebetween, and in which sealing gaskets forming an airtight line are disposed in an outer region of a region where the dummy gas diffusion layers are disposed; and an airtight adhesive which is applied to a space between the dummy gas diffusion layers and the sealing gaskets between the pair of separators to prevent the reaction gas flown into one separator of the pair of separators from flowing to the other separator.

The compressibility of the airtight adhesive is greater than those of the dummy gas diffusion layers and the sealing gaskets.

In the reaction cell, a reaction region is formed in the center, and a pair of manifold regions in which a plurality of manifolds through which reaction gas or cooling water is flown into or discharged are formed to be penetrated are respectively formed on both sides of the reaction region. In the dummy cell, an inner region is formed in a position corresponding to the reaction region of the reaction cell, an outer region is formed in a position corresponding to the pair of manifold regions, and the airtight adhesive is applied to a region where the inner region and the outer region are in contact with each other.

The reaction gas flown into the dummy cell flows into one of a pair of outer regions formed on the pair of separators, passes between one of the pair of separators and the dummy gas diffusion layers, and then is discharged to the other of the pair of outer regions, and the reaction gas is not flown into between the other of the pair of separators and the dummy gas diffusion layers.

The airtight adhesive is applied to a space except for a path through which the reaction gas is flown into or discharged from the dummy gas diffusion layers in the space between the dummy gas diffusion layers and the sealing gaskets.

The reaction cell includes: a membrane-electrode assembly; a sub gasket surrounding and supporting an edge of the membrane-electrode assembly; a pair of gas diffusion layers laminated on both surfaces of the membrane-electrode assembly; and a pair of separators which are laminated with the pair of gas diffusion layers interposed therebetween, and in which sealing gaskets forming an airtight line are disposed in a region where the sub gasket is disposed, wherein the dummy gas diffusion layers are formed to a size smaller than that of the gas diffusion layers of the reaction cell.

In the reaction cell, the sub gasket and the pair of gas diffusion layers overlap each other to form an overcompression section, and the dummy gas diffusion layers are not disposed in the overcompression section.

According to the embodiment of the present disclosure, a dummy cell having a flow pressure of the reaction gas similar to that of the reaction cell can be implemented by applying an airtight adhesive to block the reaction gas flown into a separator of one side from flowing to a separator of the other side in the dummy cell.

Accordingly, since the flow rate loss of the reaction gas flowing to the dummy cell can be minimized without affecting the surface pressure of the reaction cell in the stack, the flow rate of the reaction gas flowing to the reaction cell can be sufficiently secured, thereby enabling improvement of dischargeability of produced water together with improvement of the stack performance.

### BRIEF DESCRIPTION OF THE DRAWINGS

FIG. 1 is a view showing a configuration of a general fuel cell stack and a flow of a reaction gas;

FIG. 2A is a view showing a separator constituting a dummy cell of the general fuel cell stack;

FIGS. 2B and 2C are views showing main parts of FIG. 2A.

FIG. 3 is a view showing cross sections of a reaction cell and a dummy cell of the general fuel cell stack;

FIG. 4 is a view showing a configuration of a fuel cell stack according to one embodiment of the present disclosure and a flow of a reaction gas;

FIG. 5 is a view showing a position where an airtight adhesive is applied in a dummy cell for a fuel cell according to one embodiment of the present disclosure; and

FIG. 6 is a view showing cross sections of a reaction cell and a dummy cell of the fuel cell stack according to one embodiment of the present disclosure.

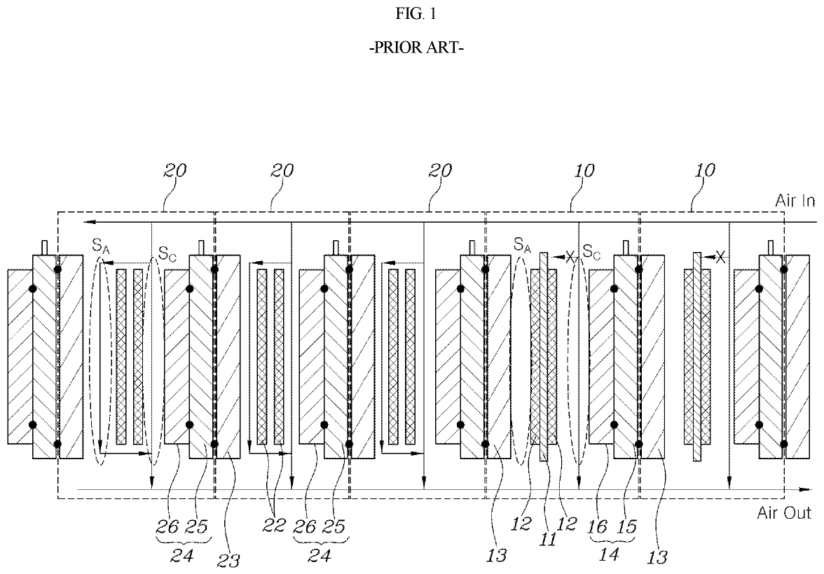

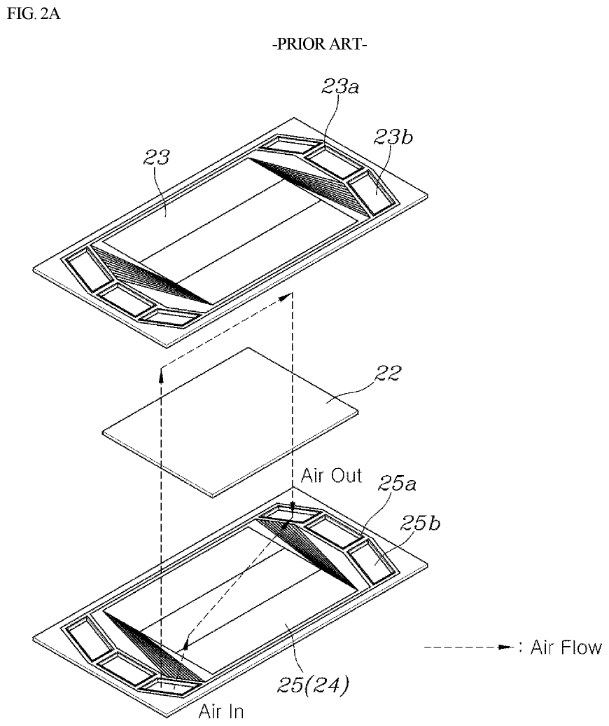

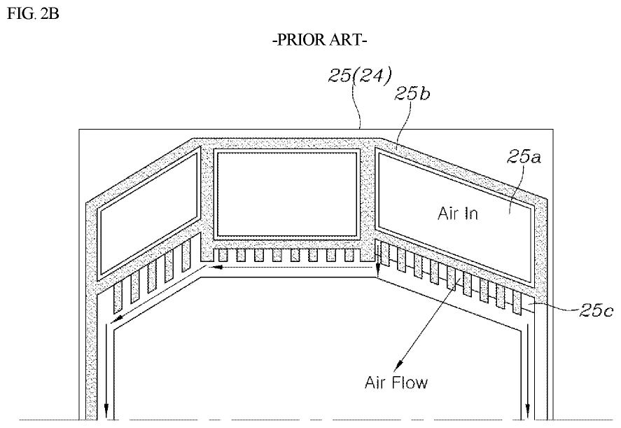

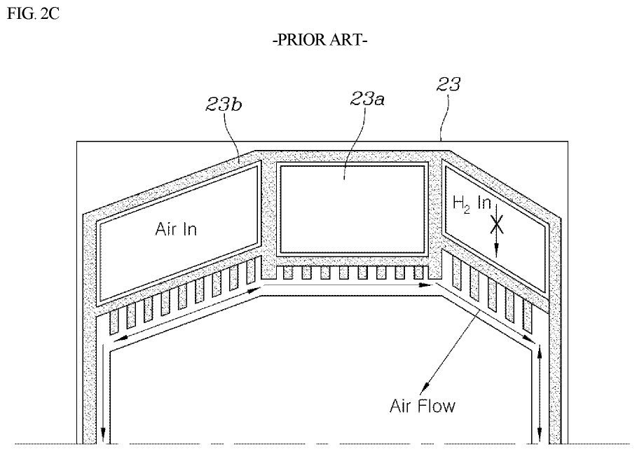

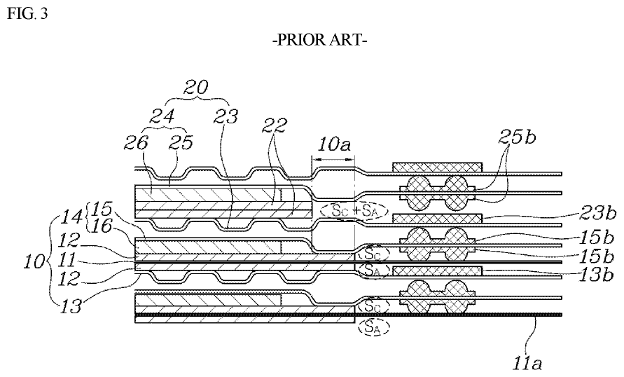

### DETAILED DESCRIPTION OF ILLUSTRATIVE EMBODIMENTS

Hereinafter, the embodiments disclosed in the present specification will be described in detail with reference to the accompanying drawings, but the same or similar components are assigned the same reference numerals regardless of reference numerals, and overlapping descriptions thereof will be omitted.

The suffixes “module” and “part” for the components used in the following description are given or mixed in consideration of only the ease of writing the specification, and do not have distinct meanings or roles by themselves.

In describing the embodiments disclosed in the present specification, if it is determined that detailed descriptions of related known technologies may obscure the gist of the embodiments disclosed in the present specification, the detailed descriptions thereof will be omitted. In addition, the accompanying drawings are only for easy understanding of the embodiments disclosed in the present specification, and the technical spirit disclosed in the present specification is not limited by the accompanying drawings, and it should be understood that the present disclosure includes all changes, equivalents and substitutes included in the spirit and technical scope of the present disclosure.

Terms including ordinal numbers such as first, second, etc. may be used to describe various constituent elements, but the constituent elements are not limited by the terms. The above terms are used only for the purpose of distinguishing one constituent element from another.

When one constituent element is mentioned as being “coupled” or “connected” to another constituent element, it should be understood that one constituent element can be coupled or connected directly to another constituent element, but another constituent element can also be present between the constituent elements. Meanwhile, when one constituent element is mentioned as being “coupled directly to” or “connected directly to” another constituent element, it should be understood that another constituent element is not present between the constituent elements.

Singular expressions include plural expressions unless clearly described as different meanings in the context.

In the present specification, it should be understood that the terms such as “comprises” or “have” are intended to specify the existence of a feature, number, step, operation, element, component, or a combination thereof described in the specification, but do not preclude the existence or addition possibility of one or more other features, numbers, steps, operations, elements, components, or combinations thereof.

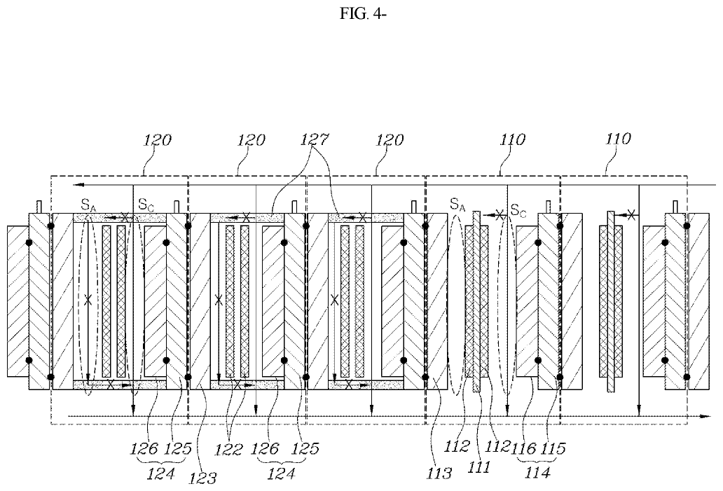

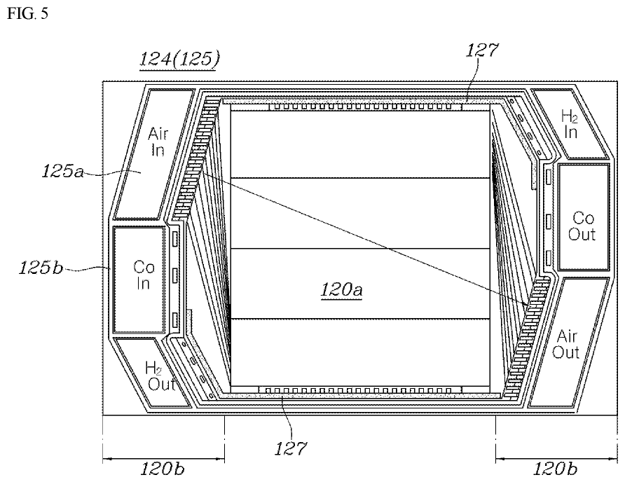

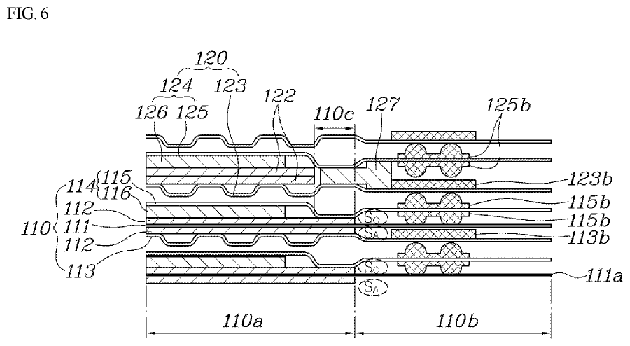

FIG. 4 is a view showing a configuration of a fuel cell stack according to one embodiment of the present disclosure and a flow of a reaction gas, FIG. 5 is a view showing a position where an airtight adhesive is applied in a dummy cell for a fuel cell according to one embodiment of the present disclosure, and FIG. 6 is a view showing cross sections of a reaction cell and a dummy cell of the fuel cell stack according to one embodiment of the present disclosure.

As shown in FIG. 4, the fuel cell stack to which the dummy cell according to one embodiment of the present disclosure is applied includes a plurality of reaction cells 110 stacked on each other and at least one pair of dummy cells 120 stacked with the plurality of stacked reaction cells 110 interposed therebetween.

At this time, unit cells applied to a general fuel cell stack may be applied to a reaction cell 110.

For example, in the reaction cell 110, a membrane-electrode assembly (MEA) 111 is positioned at the innermost side, and a pair of gas diffusion layers 112 are laminated on both surfaces of the membrane-electrode assembly (111). In addition, an anode separator 113 to which hydrogen, that is a reaction gas, is supplied is laminated on the gas diffusion layer 112 of one side, and a cathode separator 114 to which air, that is a reaction gas, is supplied is laminated on the gas diffusion layer 112 of the other side.

At this time, a reaction region 110a in which hydrogen and air (oxygen) are reacted is formed in the center of the reaction cell 110, and a pair of manifold regions 110b in which a plurality of manifolds 113a and 115a through which reaction gas or cooling water is flown into or discharged are formed to be penetrated are respectively formed on both sides of the reaction region 110a.

Meanwhile, the membrane-electrode assembly 111 is supported by being surrounded by a sub gasket ma. At this time, the membrane-electrode assembly in and the sub-gasket 111a manufactured in the form of a film are integrated by laminating portions that overlap each other. Accordingly, as shown in FIG. 6, a section (hereinafter, referred to as an “overcompression section 110c”) in which the membrane-electrode assembly in and the sub gasket 111a are overcompressed while overlapping is generated.

In addition, a flow field-type separator formed in a structure in which lands and channels are repeatedly bent is applied as the anode separator 113, and a porous separator composed of a flat plate 115 and a porous body 116 is applied as the cathode separator 114. Of course, the shape of the separator is not limited to the presented embodiment, but the porous separator may be applied as the anode separator, the flow field-type separator may be applied as the cathode separator, and the flow field-type separator or the porous separator may be applied as both the anode separator and the cathode separator.

Meanwhile, since the dummy cell 120 is not a power generation cell, the dummy cell 120 is formed in a configuration in which the membrane-electrode assembly is omitted from the configuration of the reaction cell.

However, since the gas diffusion layers 122 applied to the dummy cell 120 are formed to a size different from that of the gas diffusion layers 112 applied to the reaction cell 110, they will be referred to as “dummy gas diffusion layers 122” so as to be distinguished from the gas diffusion layers 112 applied to the reaction cell 110.

The dummy cell 120 according to the present disclosure includes an airtight adhesive 127 which is applied to a space between the dummy gas diffusion layers 122 and the sealing gaskets 123b and 12513, between a pair of separators 123 and 124 to prevent the reaction gas flown into one separator 124 of the pair of separators 123 and 124 from flowing to the other separator 123.

If it is additionally explained, since the membrane-electrode assembly is omitted in the dummy cell 120, a pair of dummy gas diffusion layers 122 are laminated to face each other.

At this time, as shown in FIG. 6, the dummy gas diffusion layers 122 are preferably formed to a size smaller than that of the gas diffusion layers 112 constituting the reaction cell 110 in order to avoid that the dummy gas diffusion layers 122 are disposed in a section corresponding to the overcompression section woe formed while the membrane-electrode assembly in and the sub gasket 111a overlap in the reaction cell 110. Therefore, it is preferable that the dummy gas diffusion layers 122 are not disposed in the overcompression section woe.

Then, a pair of separators 110 and 120 are laminated with a pair of dummy gas diffusion layers 122 interposed therebetween.

At this time, for the pair of separators 113 and 114, that is, the anode separator 113 and the cathode separator 114, the flow field-type separator is applied as the anode separator 113, and the porous separator is applied as the cathode separator 114 as in the above-described reaction cell 110.

In addition, in the dummy cell 120, an inner region 120a is formed in a position corresponding to the reaction region 110a of the reaction cell 110, and an outer region 120b is formed in a position corresponding to the pair of manifold regions 110b.

Therefore, the airtight adhesive 127 is applied to a region where the inner region 120a and the outer region 120b are in contact with each other.

Meanwhile, sealing gaskets 123b and 125b forming an airtight line for ensuring airtightness of the reaction gas or cooling water are disposed on the anode separator 123 and the cathode separator 124.

At this time, the sealing gaskets 12313, and 12513, form a closed loop-type airtight line surrounding the edges of the inner region 120a and the outer region 120b so that the reaction gas does not leak while surrounding a plurality of manifolds 123a and 125a formed in the outer region 120b.

Therefore, the sealing gaskets 12313, and 125b are disposed in various forms even in the outer region of the region where the dummy gas diffusion layers 122 are disposed as shown in FIG. 6.

Accordingly, the airtight adhesive 127 is applied to the space between the dummy gas diffusion layers 122 and the sealing gaskets 123b and 125b between the anode separator 123 and the cathode separator 124.

Meanwhile, it is preferable to apply a material having a compressibility greater than those of the dummy gas diffusion layers 122 and the sealing gaskets 123b and 125b to the airtight adhesive 127.

The reason for limiting the compressibility of the airtight adhesive 127 in this way is that if the compressibility of the airtight adhesive 127 is smaller than those of the dummy gas diffusion layers 122 and the sealing gaskets 123b and 125b, the airtight adhesive 127 serves as a stopper during stacking of the stack so that the anode separator 123 and the cathode separator 124 are not stacked to a desired level, which may cause a problem in airtightness. And, it does not affect the surface pressure of the adjacent reaction cell 110.

Further, it is preferable that the airtight adhesive 127 is adhered by the pressure given during stacking of the stack at room temperature by applying a hot melt-type pressure sensitive material.

The reason for limiting the airtight adhesive 127 to a pressure sensitive material in this way is that, when an adhesive of the heat sensitive material is used, the anode separator 123 and the cathode separator 124 are exposed to high temperatures during application and drying of the airtight adhesive 127 so that surface properties thereof may change.

Meanwhile, the airtight adhesive 127 is a means applied for the purpose of preventing the reaction gas from flowing to an undesired path, and as shown in FIG. 5, it is preferable that it is applied to a space except for the path through which the reaction gas is flown into or discharged from the dummy gas diffusion layers 122 in the space between the dummy gas diffusion layers 122 and the sealing gaskets 123b and 125b.

For example, the airtight adhesive 127 is preferably applied so as to surround the edge of the inner region 120a in a state in which a section which is in contact with the manifolds 123a and 125a through which the reaction gas is flown into or discharged is excluded.

A path through which the reaction gas flows in the fuel cell stack according to one embodiment of the present disclosure configured as described above will be described.

When air, which is a reaction gas, is explained as an example, as shown in FIG. 4, air flowing in the manifold region 110b of the reaction cell 110 and the outer region 120b of the dummy cell 120 is flown in and flows between the cathode separator 124 and the gas diffusion layers 112 of the reaction cell 110. At this time, the flow field of air is blocked by the sub-gasket ma so that air is blocked from flowing in between the anode separator 113 and the gas diffusion layers 112.

In addition, air flowing in the manifold region 110b of the reaction cell 110 and the outer region 120b of the dummy cell 120 is flown in and flows between the cathode separator 124 and the dummy gas diffusion layers 122 of the dummy cell 120. At this time, the flow field of air is blocked by the airtight adhesive 127 so that air is blocked from flowing in between the anode separator 123 and the dummy gas diffusion layers 122.

In this way, as paths (volumes) through which air flown into the reaction cell 110 and air flown into the dummy cell 120 flow are formed equally or similarly, the differential pressure of the reaction cell 110 and the differential pressure of the dummy cell 120 are formed similarly. Accordingly, since excessive inflow of air into the dummy cell 120 is prevented, it is possible to prevent a decrease in the efficiency of the fuel cell stack.

Although the present disclosure has been described with reference to the accompanying drawings and the above-described preferred embodiments, the present disclosure is not limited thereto, but is defined by the claims to be described later. Accordingly, those with ordinary skill in the art can variously change and modify the present disclosure within the scope without departing from the technical spirit of the claims to be described later.

What is claimed is:

1. A dummy cell for a fuel cell, the dummy cell comprising:
a pair of dummy gas diffusion layers laminated on each other;
a pair of separators which are laminated with the pair of dummy gas diffusion layers interposed therebetween, and in which sealing gaskets forming an airtight line are disposed in an outer region of a region where the dummy gas diffusion layers are disposed; and
an airtight adhesive arranged between the dummy gas diffusion layers and the sealing gaskets and between the pair of separators, the airtight adhesive configured to prevent a reaction gas flowing from one separator to another separator.

2. The dummy cell of claim 1, wherein a compressibility of the airtight adhesive is greater than a compressibility of the dummy gas diffusion layers.

3. The dummy cell of claim 1, wherein a compressibility of the airtight adhesive is greater than a compressibility of the sealing gaskets.

4. The dummy cell of claim 1, wherein the airtight adhesive is a hot melt-type pressure sensitive adhesive.

5. The dummy cell of claim 1, wherein the dummy cell does not include a membrane-electrode assembly.

6. A fuel cell stack comprising:
a plurality of reaction cells stacked on each other; and
at least one pair of dummy cells stacked with the plurality of stacked reaction cells interposed therebetween, each dummy cell comprising:
a pair of dummy gas diffusion layers laminated on each other;
a pair of separators which are laminated with the pair of dummy gas diffusion layers interposed therebetween, and in which sealing gaskets forming an airtight line are disposed in an outer region of a region where the dummy gas diffusion layers are disposed; and
an airtight adhesive arranged in between the dummy gas diffusion layers and the sealing gaskets and between the pair of separators, the airtight adhesive configured to prevent a reaction gas flowing from one separator to another separator.

7. The fuel cell stack of claim 6, wherein a compressibility of the airtight adhesive is greater than a compressibility of the dummy gas diffusion layers.

8. The fuel cell stack of claim 7, wherein a compressibility of the airtight adhesive is greater than a compressibility of the sealing gaskets.

9. The fuel cell stack of claim 6,
wherein each reaction cell comprises a reaction region in a center and a pair of manifold regions, each manifold region comprising a plurality of manifolds configured to provide or discharge reaction gas or cooling water,
wherein the dummy cell comprises an inner region corresponding to the reaction region of the reaction cell and an outer region corresponding to the pair of manifold regions, and
wherein the airtight adhesive is arranged in a region where the inner region and the outer region are in contact with each other.

10. The fuel cell stack of claim 9,
wherein the reaction gas is configured to flow into one of a pair of outer regions formed on the pair of separators, pass between one of the pair of separators and the dummy gas diffusion layers, and then discharge to the other of the pair of outer regions, and
wherein the reaction gas is not configured to flow between the other of the pair of separators and the dummy gas diffusion layers.

11. The fuel cell stack of claim 9, wherein the airtight adhesive is arranged in a space except for a path through which the reaction gas is flown into or discharged from the dummy gas diffusion layers in the space between the dummy gas diffusion layers and the sealing gaskets.

12. The fuel cell stack of claim 6, wherein each reaction cell comprises:
a membrane-electrode assembly;
a sub gasket surrounding and supporting an edge of the membrane-electrode assembly;
a pair of gas diffusion layers laminated on both surfaces of the membrane-electrode assembly; and
a pair of separators which laminated with the pair of gas diffusion layers interposed therebetween, and in which sealing gaskets forming an airtight line are disposed in a region where the sub gasket is disposed, and
wherein the dummy gas diffusion layers are a size smaller than that of the gas diffusion layers of the reaction cell.

13. The fuel cell stack of claim 12, wherein the dummy cell does not include the membrane-electrode assembly.

14. The fuel cell stack of claim 12, wherein the pair of separators are a cathode separator and an anode separator, and wherein the cathode separator comprises a flat plate and a porous body and the anode separator comprises a flow filed type separator.

15. The fuel cell stack of claim 12, wherein, in each reaction cell, the sub gasket and the pair of gas diffusion layers overlap each other to form an overcompression section, and wherein the dummy gas diffusion layers are not disposed in the overcompression section.
